(19) United States
(12) Patent Application Publication
(10) Pub. No.: US 2016/0189239 A1
(43) Pub. Date: Jun. 30, 2016

(54) ADVERTISEMENT GENERATOR

(71) Applicant: Yahoo!, Inc., Sunnyvale, CA (US)

(72) Inventors: Varun Bhagwan, San Jose, CA (US); Jaikit Savla, Santa Clara, CA (US); Doug Sharp, San Francisco, CA (US); Rahul Teotia, Sunnyvale, CA (US); Jesper Andersen, Oakland, CA (US); Deepak Agarwal, Milpitas, CA (US); Jac Wang, San Jose, CA (US)

(21) Appl. No.: 14/586,886

(22) Filed: Dec. 30, 2014

(51) Int. Cl. G06Q 30/02

(52) U.S. Cl. CPC G06Q 30/0269

(57) ABSTRACT

One or more methods and/or techniques for providing an advertisement to a user are provided herein. Message communication associated with a user may be evaluated to identify message content (e.g., a forum post soliciting a recommendation for vacuum cleaners). The message content may be evaluated to identify recommendation content (e.g., a vacuum cleaner recommendation). The recommendation content may comprise a recommendation request and/or a recommendation for the recommendation request. An advertisement corresponding to the recommendation content may be identified (e.g., a vacuum cleaner advertisement). The advertisement may be displayed to the user.

### BACKGROUND

When a user is searching for and/or considering buying a product or service (e.g., a consumer product such as running shoes, a service such as personal training, etc.), the user may attempt to research the product or service online. In an example, the user may submit a request for a recommendation for a particular product or service from community members associated with a community forum (e.g., a forum post asking for a running shoe brand recommendation). However, the user may receive unhelpful comments (e.g., a forum user may deviate from the running shoe brand recommendation request and may respond about how running hurts your joints and how people should quit running in order to take up swimming) and/or a lack of responsive comments. Thus, the user may spend extensive amounts of time and/or computing resources searching for products or services (e.g., a responsive comment may provide a recommendation to purchase cleated running shoes for running on an indoor track, but the user may have to search through many brands and/or models of cleated running shoes before making a purchase). If the user does not find an applicable product and/or service, then the user may forgo purchasing a product or service all together.

### SUMMARY

In accordance with the present disclosure, message communication (e.g., an email message, a forum post, a social network post, etc.) associated with a user may be evaluated to identify message content. In an example, the message communication may correspond to the user and/or a community member submitting a recommendation request through a community forum (e.g., a forum post “What running shoes does everyone recommend?”). In another example, the message communication may correspond to the user and/or the community member submitting a recommendation through the community forum (e.g., a recommendation “I love these new XLT100 Running Shoes”).

The message content may be evaluated to identify recommendation content. In an example, the recommendation content may comprise at least one of a recommendation request (e.g., “what is the best type of lawnmower for a half acre lot?”) or a recommendation (e.g., “try a riding lawn mower with a 54 inch deck”). In an example, suggested content, corresponding to the recommendation request, may be identified. The suggested content (e.g., content from a webpage of a lawnmower manufacture endorsing a riding lawnmower) may be provided as a recommendation for the recommendation request. In another example, a community recommendation, (e.g., a forum message submitted by a community member recommending a lawnmower with headlights) that corresponds to the recommendation request, may be identified and provided as the recommendation for the recommendation request. In another example, an archived recommendation, from a recommendation database, that corresponds to the recommendation request may be identified and provided as the recommendation for the recommendation request.

An advertisement corresponding to the recommendation content may be identified (e.g., an advertisement for a riding lawnmower). The advertisement may be provided to the user (e.g., in an email message). In an example, the providing the advertisement may comprise displaying the advertisement to the user through an email interface, a website, an application interface, and/or as a push notification.

In an example, an advertisement user interface may be displayed with the advertisement. The advertisement user interface may display at least one of a rate user interface element used to rate the advertisement, a copy user interface element used to copy a link to the advertisement, a save user interface element used to save the advertisement as a file, a share user interface element used to share the advertisement with one or more community members, or a comment user interface element used to comment on the advertisement.

Interaction information regarding user interaction with the advertisement may be collected. The interaction information may be utilized to determine at least one of whether to subsequently associate the advertisement with the recommendation request, whether to subsequently associate the advertisement with the recommendation, or whether to increase or decrease a cost of a recommendation advertisement opportunity associated with the recommendation.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of providing an advertisement to a user.

FIG. 5 is a component block diagram illustrating an example system for providing an advertisement to a user.

FIG. 6A is a component block diagram illustrating an example system for providing a coupon for an advertisement, where the advertisement is provided based upon a recommendation request.

FIG. 6B is a component block diagram illustrating an example system for providing an advertisement to a user, where the advertisement is for based upon a recommendation request and/or an archived recommendation.

FIG. 6C is a component block diagram illustrating an example system for providing an advertisement to a user, where the advertisement is for based upon a recommendation request and/or a community recommendation.

FIG. 7 is a component block diagram illustrating an example system for providing an advertisement to a user, where a user interface is displayed.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware, or any combination thereof.

1. Computing Scenario

The following provides a discussion of some types of computing scenarios in which the disclosed subject matter may be utilized and/or implemented.

1.1. Networking

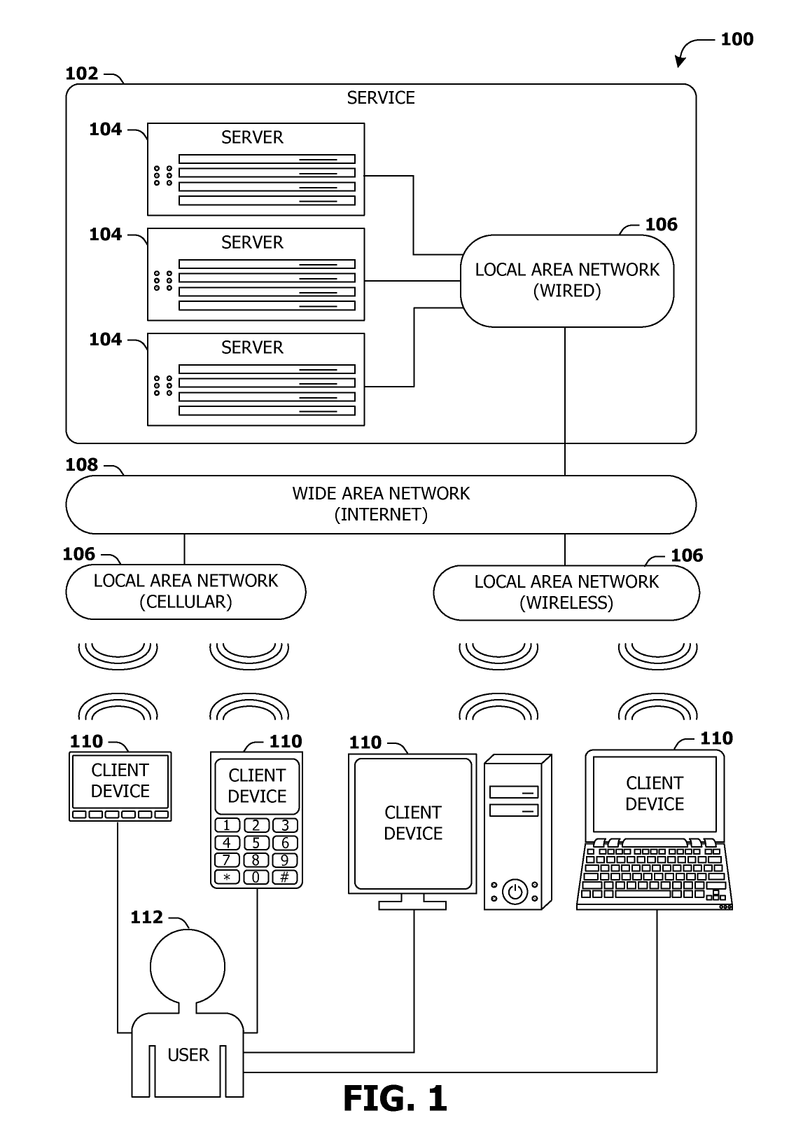

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

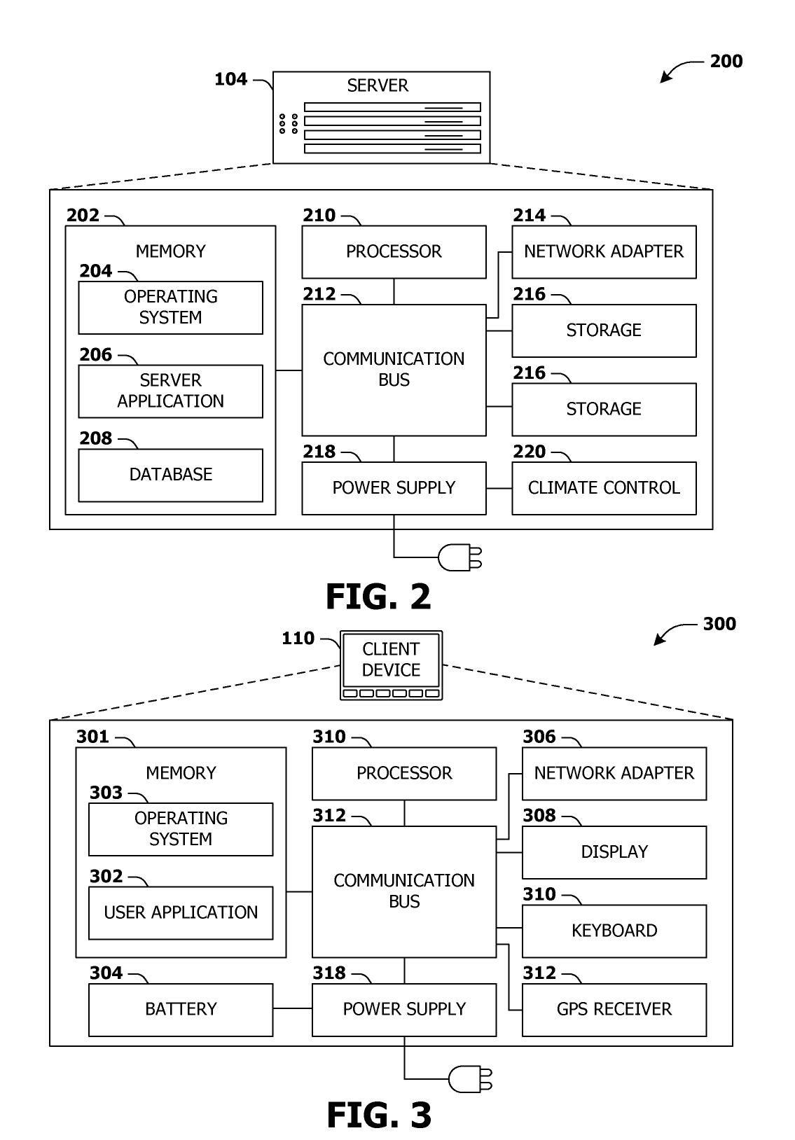

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for providing an advertisement to a user are provided herein. A user on a client device (e.g., smartphone, personal computer, tablet, laptop computer, etc.) may submit a recommendation request, such as for a product (e.g., dog collar), a service, (e.g., dog walker), and/or a problem (e.g., how to train training a dog to heel). The user may, responsive to receiving a recommendation for the recommendation request, search for products and/or services that correspond to the recommendation, and/or search for a provider (e.g., a business, an individual, etc.) that offer the products and/or services for purchase (e.g., a Pet Store).

As provided herein, an advertisement may be provided to a user based upon recommendation content (e.g., a recommendation request, a recommendation for the recommendation request, etc.) within message communication of the user. In an example, the message communication (e.g., email message) may be evaluated to identify message content (e.g., text of the email message). The message content may be evaluated to identify recommendation content, such as a recommendation request and/or a recommendation. In an example, responsive to identifying a recommendation request, a corresponding recommendation may be determined for the recommendation request. For example, suggested content, such as an archived recommendation (e.g., a previously provided recommendation to a second user) and/or a community member recommendation (e.g., a community forum may be crawled to identify recommendation information for the recommendation request) may be identified. The suggested content may be provided as the recommendation for the recommendation request. The advertisement may be identified based upon the advertisement corresponding to the recommendation content (e.g., the recommendation request and/or the recommendation). The advertisement may be provided to the user, such as through email interface, a text message interface, a webpage interface, a mobile application interface, etc.

The ability to provide users with relevant recommendations and/or advertisements for recommendation requests of the user may mitigate computing resources (e.g., battery power consumption, processing resources, bandwidth, etc.) and/or time otherwise wasted by performing multiple searches and/or submitting multiple recommendation requests in an attempt to identify relevant information for a product, service, etc. (e.g., no recommendations may be received in response to the recommendation request being submitted to a community forum; an unhelpful recommendation for a cat collar may be received in response to a recommendation request for a large dog collar; an unhelpful recommendation for a Pet Store 300 miles away may be received; etc.). Providing recommendations and/or advertisements to the user may aid the user in quickly and efficiently identifying relevant products and/or services to consume .

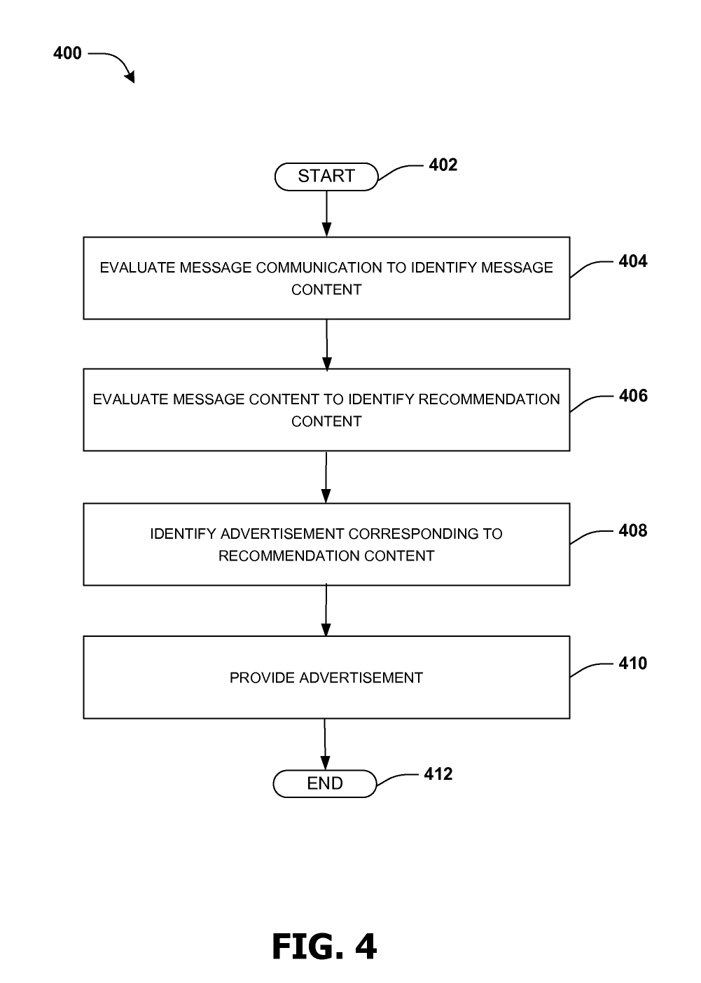

An embodiment of providing an advertisement to a user is illustrated by an example method 400 of FIG. 4. At 402, the method 400 starts. At 404, message communication associated with a user may be evaluated to identify message content. The message communication may comprise at least one of an email message, an instant message, a forum message, a social media message, a social network post, an in-app message (e.g. a notification), a video message, a text message, or an audio message. The message communication may comprise message content, such as recommendation content (e.g., a recommendation request, a recommendation in response to a recommendation request, etc.), message creator information (e.g., name, age, gender, education level, location, and/or other information about a creator of the message communication), image content, video content, time stamp content, etc. In an example, the message communication may correspond to communication activity that corresponds to the user and/or a community member sending and/or receiving a message (e.g., the user may send an instant message to the community member recommending a product; the user may submit a forum message to a community forum requesting a recommendation for the product; the user may receive a text message from the community member requesting a recommendation for a solution to a problem; the community member may receive a notification from a mobile app that a forum message containing a recommendation for a service has been submitted to the community forum; etc.).

At 406, the message content may be evaluated to identify recommendation content within the message communication. The evaluation of the message content may be based upon an evaluation of a feature of the message communication, such as text of the message communication. In an example, a textual analysis (e.g., a process for analyzing the text based upon at least one of a lexical analysis process, a pattern recognition process, a tagging/annotation process, an information extraction process, a data mining process such as a link and association process, an entity identification process, a visualization process, or a predictive analytics process) may be performed on the text of the message communication to identify portion of text corresponding to the recommendation content. In an example, the recommendation content may be evaluated to identify a product (e.g., a vacuum), a service (e.g., a carpet cleaning service), a problem (e.g., “how do you clean up pet hair”), and/or solution associated with the recommendation content.

In an example, the recommendation content may comprise a recommendation request (e.g., a question directed to a product, a service, a problem, etc.) and/or a recommendation (e.g., a user suggestion). For example, a recommendation request, such as “which vacuums are the best at picking up pet hair?” may be identified from message content of a forum post. In an example, a string of message communication (e.g., a first message, a second message that is a reply to the first message, etc.) may be evaluated to identify recommendation content. For example, a first forum message comprising a recommendation request and a second forum message comprising a recommendation for the recommendation request may be combined to generate a community forum summary message. The community forum summary message may be evaluated to identify recommendation content corresponding to the first forum message and the second forum message.

In an example where the recommendation content corresponds to a recommendation request, a recommendation may be identified for the recommendation request. For example, suggested content corresponding to the recommendation request may be identified. The suggested content may be provided as the recommendation for the recommendation request. The suggested content may comprise content (e.g., an archived recommendation previously provided to a second user, a user/community recommendation, etc.) identified from at least one of a webpage, a community forum (e.g., an online message board for holding a conversation in the form of posted messages), a blog post, a social network profile, an article, a newsfeed, a recommendation database, a user profile, an application (e.g., a weather forecast application), or a search engine page. In an example, suggested content may comprise content identified from a webpage for a manufacture of a first vacuum based upon the webpage indicating that the first vacuum has brushes designed to pick up pet hair better than brushes of a second vacuum. The first vacuum model may be provided as the recommendation for the recommendation request.

At 408, an advertisement, corresponding to the recommendation content, may be identified. In an example, an advertisement search may be performed to identify an advertisement corresponding to the recommendation content. The advertisement search may identify advertisements corresponding to a product, a service, a problem and/or a solution associated with the recommendation request and/or recommendation content. In an example, the advertisement search may be performed on an advertisement database and/or an advertisement-bidding platform.

In an example, the identifying the advertisement may comprise evaluating a user profile of the user. The user profile may comprise user information, such as age, gender, geographic location, previous activities of the user (e.g., joining and/or participating in a Caring For Long Haired Dog forum), user created content of the user (e.g., a social network post stating “I really love German Shepard dogs”, a wishlist on a retail site containing the first vacuum, etc.), browser history of the user, and/or other user trait information that may be indicative of an interest in the advertisement. In an example, a first advertisement, but not a second advertisement, may be selected based upon the first advertisement, but not the second advertisement, corresponding to the user profile of the user. For example, a user profile may be evaluated to determine that the user is located in Cleveland. Responsive to determining that first user is located in Cleveland, a first advertisement for a Vacuum Store located in Cleveland, but not a second advertisement for a Chicago Vacuum Store in Chicago, may be identified based upon the location of the user. In another example, a first advertisement for an American made vacuum may be selected, but not a second advertisement for a non-American made vacuum, based upon a social network post indicating that the user has a preference for locally made consumer goods.

In an example, the advertisement may be directed to a provider that offers a product and/or service associated with the recommendation content. For example, the advertisement may be directed to a Vacuum Store that sells robotic vacuums. In another example, the advertisement may be directed to a Cleaning company that offers cleaning services such as carpet cleanings.

The advertisement may comprise at least one of a video advertisement, an interactive advertisement (e.g., Flash advertisements, GIF advertisements, etc.), an expanding advertisement (e.g., an advertisement that changes form such as, starting out as a static advertisement and then expanding to a full screen interactive video advertisement), an imagery advertisement (e.g., a static advertisement, a hyperlink advertisement, etc.), and/or any other type of advertisement.

At 410, the advertisement may be provided to the user. In an example, the advertisement may be displayed to the user through at least one of an email interface, a text message interface, an instant message interface, a website such as a web page interface, an application interface, a push notification, etc. For example, the advertisement may be displayed to the user as an expanding advertisement through a community forum webpage through which the message communication occurred (e.g., the advertisement may be display during a subsequent visit by the user to the community forum webpage).

In an example, a set of advertisements may be identified and ranked to create a ranked set of advertisements. In an example, the set of advertisement may be ranked based upon a ranking metric. The ranking metric may be based upon at least one of a user profile, a user search history, a recommendation rating (e.g., an indication whether other community members found a recommendation accurate and/or useful), an advertisement rating (e.g., an indication of whether other community members found the advertisement relevant), or an advertising budget of an advertiser. In an example, a ranking score may be assigned to the advertisements within the set of advertisements based the ranking metric. In an example, an advertisement, within the set of ranked advertisement, with the greatest ranking score may be provided to the user.

In an example, one or more recommendations corresponding to a recommendation request may be displayed in a recommendation interface associated with the advertisement. For example, a recommendation from a community member stating “robot vacuums work great for picking up dog hair” may be incorporated into a recommendation interface associated with a robot vacuum advertisement.

In an example, an advertisement user interface may be displayed. The advertisement user interface may be configured to allow the user to interact with the advertisement (e.g., expand or minimize the advertisement, receive additional information regarding the content of the advertisement, share the advertisement, comment on the advertisement, etc.). The advertisement user interface may comprise a rate user interface element used to rate the advertisement, a copy user interface element used to copy the advertisement (e.g., copy a link to the advertisement, copy a link to a webpage for a product or a service associated with the advertisement, copy to a wishlist, etc.), a save user interface element used to save the advertisement as a file, a share user interface element used to share the advertisement with one or more community members (e.g., share the advertisement with one or more community members through a community forum associated with the communication activity, share the advertisement with a community member through a non-public message communication, etc.), and/or a comment user interface element used to comment on the advertisement (e.g., the comment may be shared with other users). In an example, the advertisement may be shared with one or more community members through a community forum associated with the communication activity in response to the user selecting the share user interface element. In another example, the advertisement may be shared with a community member through a non-public message communication (e.g., an instant message, an email message, a text message, etc.) in response to the user selecting the share user interface element.

In an example, interaction information regarding user interaction with the advertisement may be collected. The interaction information may be utilized to determine whether to subsequently associate the recommendation with the recommendation request (e.g., the user may indicate that the a broom recommendation was not helpful in finding a product for managing pet hair), whether to subsequently associate the advertisement with the recommendation content (e.g., a user purchase of an advertised Pet Vacuum may indicate that a Pet Vacuum advertisement should be associated with the recommendation content), and/or whether to increase or decrease a cost of an advertisement opportunity (e.g., the cost to associate an dog brush advertisement with a recommendation request “how do you clean up pet hair” may be increased based upon interaction information indicating that the user may be more likely to share the dog brush advertisement with a community member, visit a website associated with the dog brush advertisement, and/or subsequently purchase the dog brush in response to viewing the dog brush advertisement). At 412, the method 400 ends.

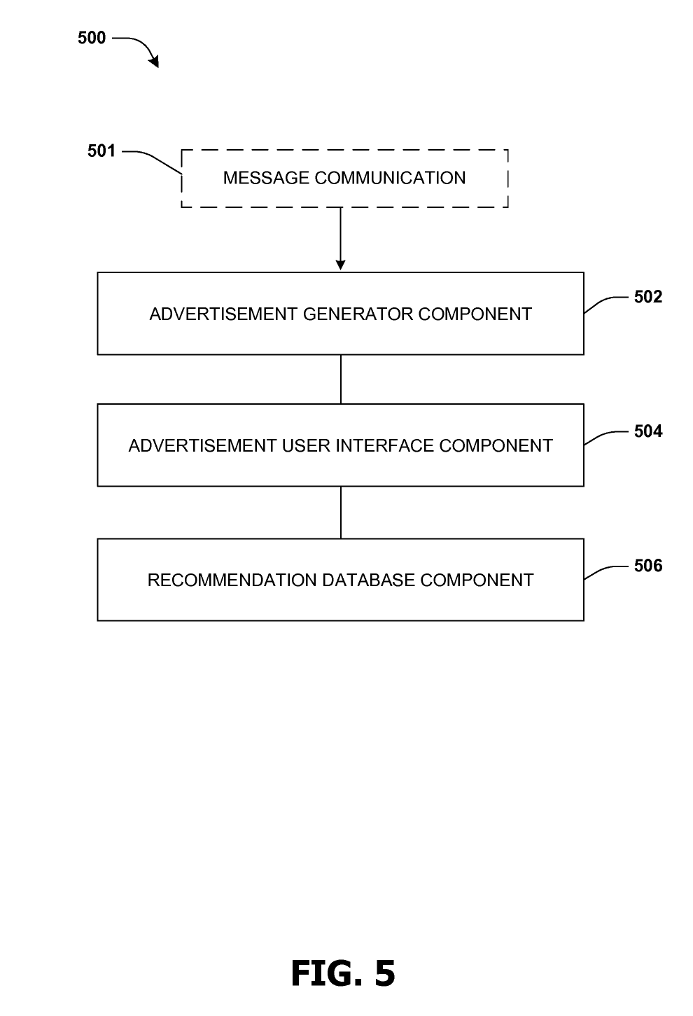

FIG. 5 illustrates the system 500 comprising at least one of an advertisement generator component 502, an advertisement user interface component 504, or a recommendation database component 506. The advertisement generator component 502 may be configured to evaluate message communication 501 (e.g., email message, forum message, etc.) of a user to identify message content (e.g., text, text extracted from an audio or video file, etc.) corresponding to a communication activity (e.g., receiving an email message, posting a forum message to a thread, etc.). The advertisement generator component 502 may evaluate the message content to identify recommendation content (e.g., a recommendation request, a recommendation, etc.) within the message communication.

In response to the message communication comprising a recommendation request, the advertisement generator component 502 may be configured to identify a recommendation for the recommendation request. For example, the advertisement generator component 502 may identify suggested content corresponding to the recommendation request and provide the suggested content as a first recommendation for the recommendation request. In an example, the suggested content may comprise an archived recommendation (e.g., a past recommendation for a past recommendation request) identified from a recommendation database or a community recommendation identified from forum communication on a community form.

The advertisement generator component 502 may identify an advertisement corresponding to the recommendation content (e.g., the recommendation request and/or the recommendation). The advertisement generator component 502 may provide the advertisement to the user.

The advertisement user interface 504 may be utilized to allow the user to interact with the advertisement provided by the advertisement generator component 502. The advertisement user interface component 504 may be configured to display at least one of a rate user interface element, a copy user interface element, a save user interface element, a share user interface element, or a comment user interface element to the user. In an example, the user may interact with the advertisement by selecting a user interface element. In response to the user selecting a user interface element, the advertisement user interface component 504 may be configured to rate the advertisement, copy the advertisement, save the advertisement as a file, share the advertisement, or comment on the advertisement. In an example, interaction information may be collected based upon how the user interacts with the advertisement (e.g., did the user visit a webpage associated with the advertisement, did the user find the advertisement relevant based upon the rating, did the user purchase a product associated with the advertisement, etc.).

In an example, the recommendation may be displayed in an interface associated with the advertisement. The advertisement user interface component 504 may be configured to rate, copy, save, share, and/or comment on the recommendation. For example, the user may utilize the advertisement user interface component 504 to rate a relevance of the advertisement and/or the recommendation to the recommendation request by submitting rating information though the rate user interface element. The rating information may be utilized to determine whether the advertisement and/or the recommendation will subsequently be associated with a recommendation request.

The recommendation database component 506 may be configured to store the recommendation as an archived recommendation. In an example, the recommendation database component 506 may be configured to request permission to store the recommendation, as an archived recommendation, in response to the recommendation being submitted by a user (e.g., submitted through a forum message, an instant message, a social network message, etc.) and/or identified (e.g., identified from a suggested content, a search, etc.) by the advertisement generation component 502.

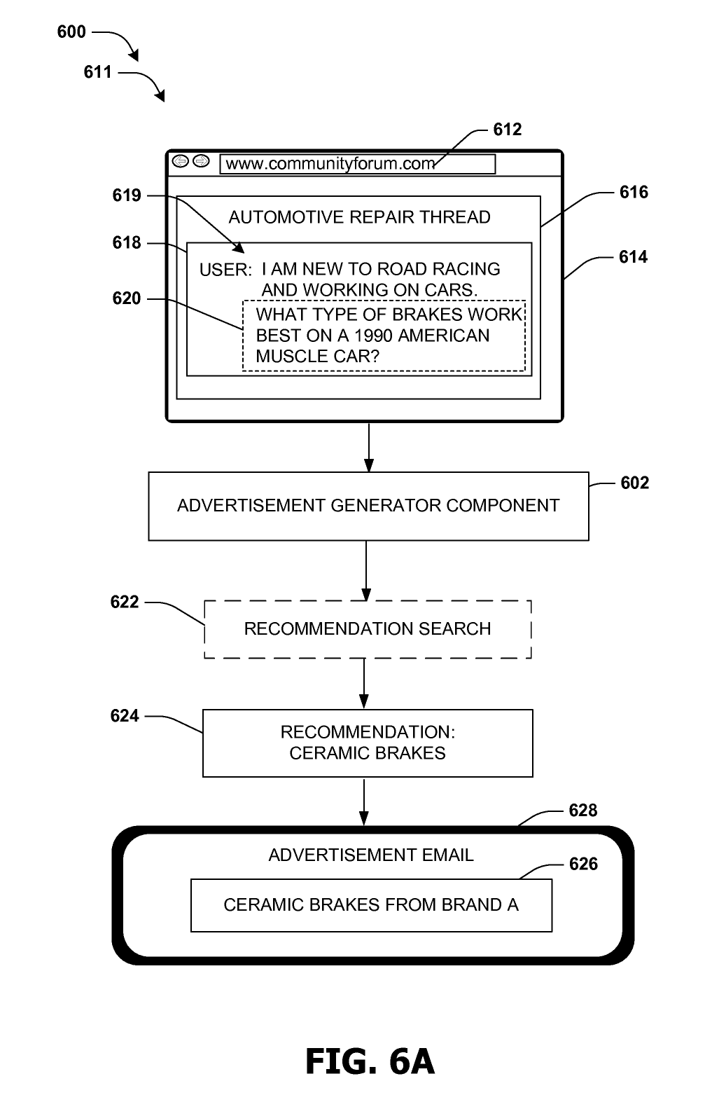

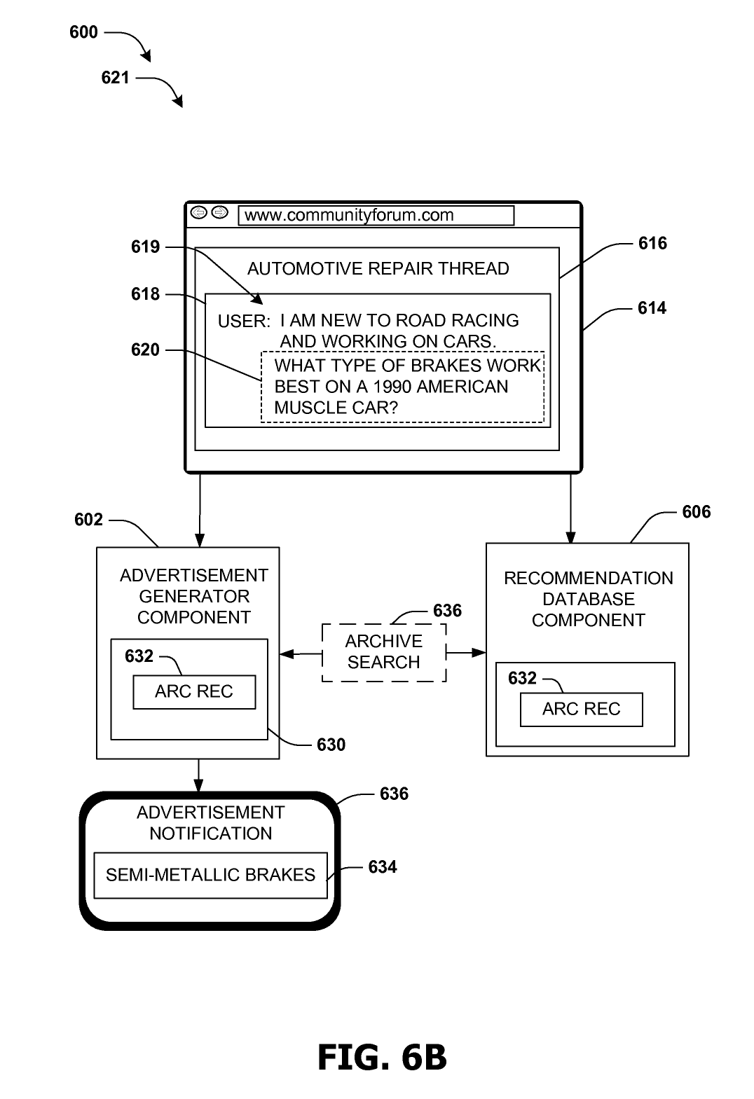

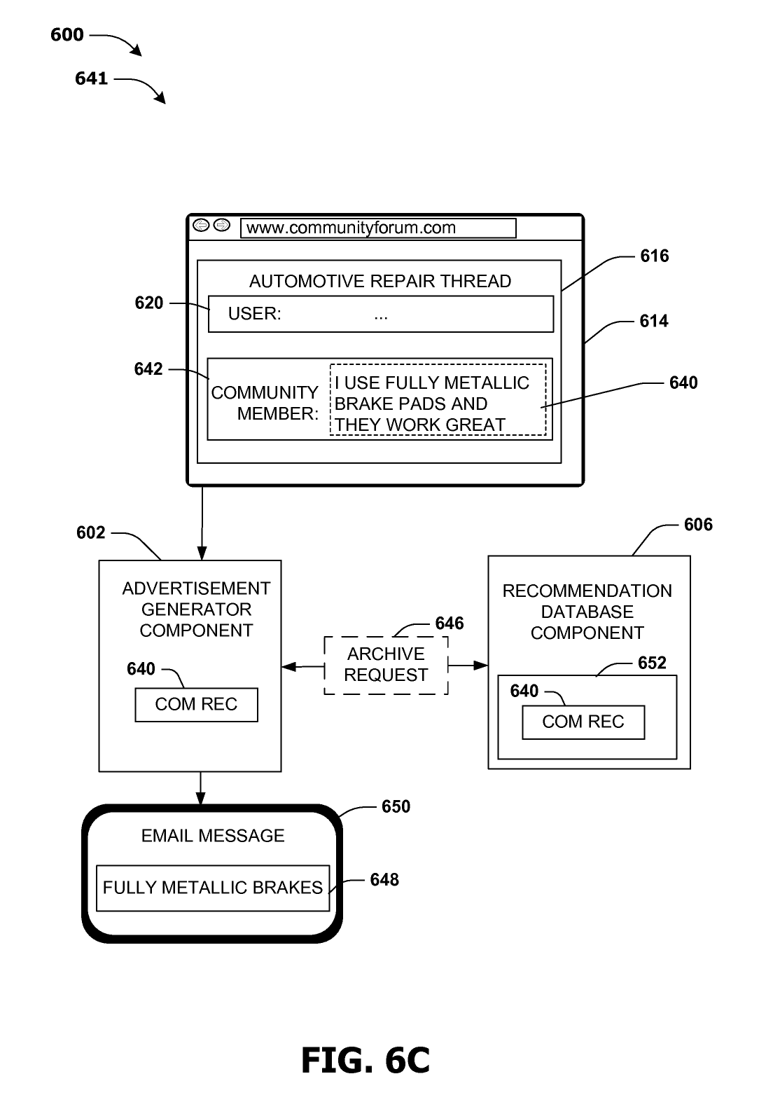

FIGS. 6A-6C illustrate a system 600, comprising an advertisement generator component 602, for providing advertisements to a user. FIG. 6A illustrates an example 611 of the advertisement generator component 602 providing the advertisement 626 based upon a recommendation request 620 submitted by the user through a community forum 612. In an example, the user may access a webpage corresponding to the community forum 612 through a web browser 614. The community forum 612 may comprise one or more threads (e.g., discussion topics within the community forum), such as automotive repair thread 616. In an example, the user may submit (e.g., post, publish, etc.) a forum message 618 comprising message content 619 to the automotive repair thread 616. The advertisement generator component 602 may evaluate the forum message 618 to identify a recommendation request 620. For example, the recommendation request 620 may comprise the question “What type of brakes work best on a 1900 American Muscle Car?” In an example, a recommendation search 622 of a brake manufacturer website may be performed to identify a recommendation 624 for ceramic brakes. The advertisement 626 may be identified based upon the recommendation request 620 and/or the recommendation 624. The advertisement 626 and/or the recommendation 624 may be displayed to the user, such as within an email message 628 accessible through an email interface.

FIG. 6B illustrates an example 621 of the advertisement generator component 602 providing an advertisement 634 corresponding to the recommendation request 620 and an archived recommendation 632 from a recommendation database component 606. In an example, in response to identifying the recommendation request 620, the advertisement generator component 602 may perform an archive search 636 of the recommendation database component 606. In an example, the archived recommendation 632 may be identified based upon the archived recommendation 632 corresponding to the recommendation request 620 (e.g., the archived recommendation 632 may have been previously submitted to another thread in response to a recommendation request that is similar to the recommendation request 620). For example, the archived recommendation 632 may recommend semi-metallic brakes. The archived recommendation 632 may be provide by the advertisement generator component 602 as recommendation 630. The advertisement 634 (e.g., a semi-metallic brake company advertisement) may be identified based upon the recommendation request 620 and/or the recommendation 630. The advertisement 634 and/or the recommendation 630 may be displayed to the user through an advertisement notification message 636 on a mobile device (not illustrated).

FIG. 6C illustrates an example 641 of the advertisement generator component 602 providing an advertisement 648 corresponding to the recommendation request 620 and a community recommendation 640 submitted by a community member as a response to the recommendation request 620 submitted through the automotive repair thread 616. In an example, in response to identifying the recommendation request 620, the advertisement generator component 602 may identify the community recommendation 640 from a second forum message 642 submitted to the automotive repair thread 616. The advertisement generator component 602 may determine that the community recommendation 640 corresponds to the recommendation request 620. For example, the community recommendation 640 may recommend using fully metallic brakes. The advertisement 648 may be identified based upon the recommendation request 620 and/or the community recommendation 640. The advertisement 648 and/or the community recommendation 640 may be displayed to the user, such as within an email message 650.

In an example, the advertisement generator component 602 may submit an archive request 646 to the recommendation database component 606 to store the community recommendation 640 as an archived recommendation 652. The archived recommendation 652 may comprise information about the recommendation request 620, the user, and/or the community member.

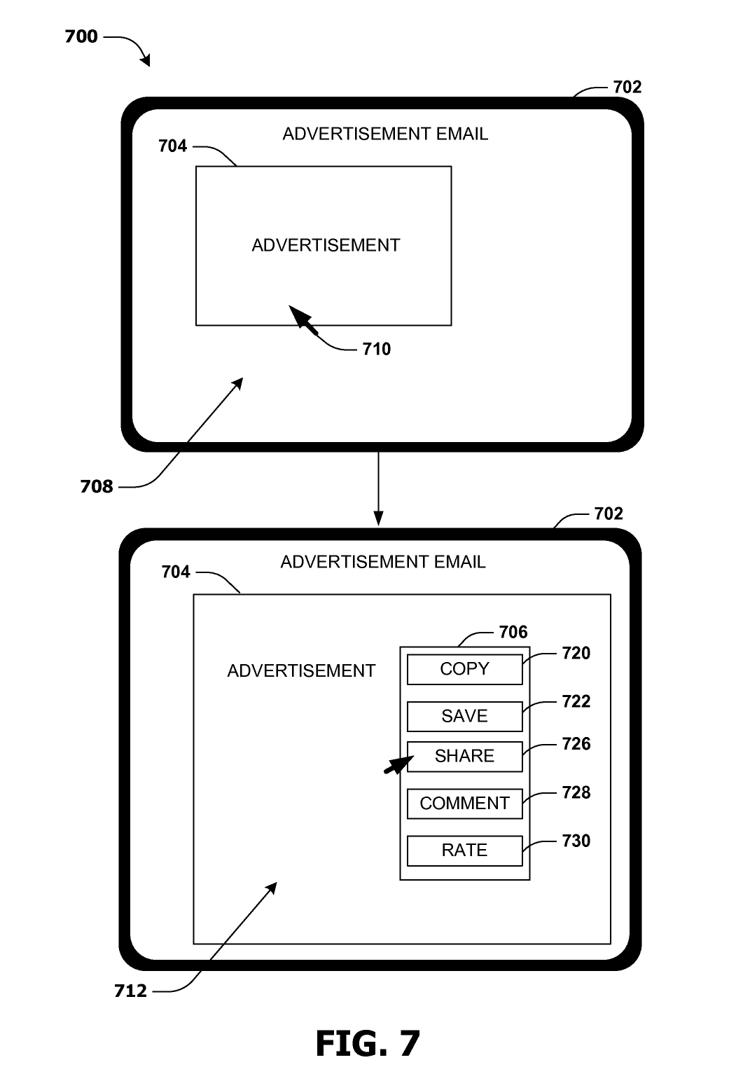

FIG. 7 illustrates a system 700 comprising an email interface 702 that is providing an advertisement 704. In an example, the email interface 702 may display the advertisement 704 in a first state 708. The advertisement 704 may comprise a mechanism to access additional information about an advertised product. Responsive to a first interaction 710 with the advertisement 704, an advertisement user interface 706 may be displayed and the advertisement 704 may be displayed in a second state 712. The advertisement user interface 706 may comprise at least one of a rate user interface element 730 used to rate the advertisement 704, a copy user interface element 720 used to copy the advertisement 704, a save user interface element 722 used to save the advertisement 704 as a file, a share user interface element 726 used to share the advertisement 704 with one or more community members, or a comment user interface element 728 used to comment on the advertisement.

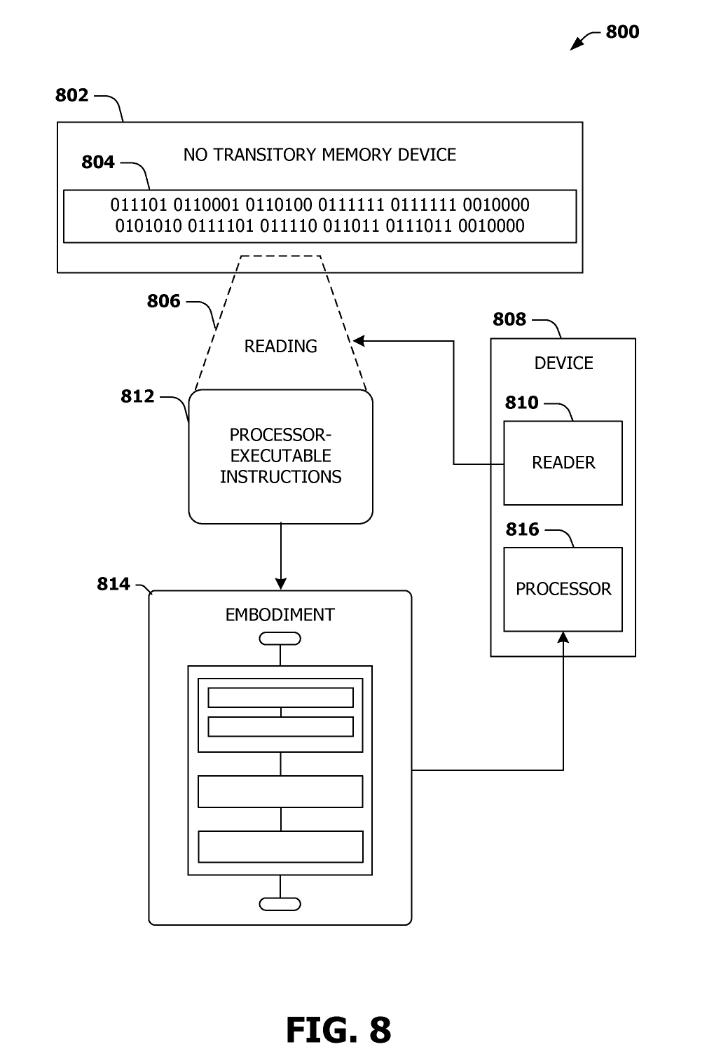

FIG. 8 is an illustration of a scenario 800 involving an example nontransitory memory device 802. The nontransitory memory device 802 may comprise instructions that when executed perform at least some of the provisions herein. The nontransitory memory device 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example method 400 of FIG. 4, for example. In some embodiments, the processor-executable instructions, when executed on the processor 816 of the device 808, are configured to implement a system, such as at least some of the example system 500 of FIG. 5, at least some of the example system 600 of FIG. 6A-C, and/or at least some of the example system 700 of FIG. 7, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of providing an advertisement to a user, comprising:
evaluating message communication associated with a user to identify message content;
evaluating the message content to identify recommendation content;
identifying an advertisement corresponding to the recommendation content; and
providing the advertisement to the user.

2. The method of claim 1, the providing comprising:
displaying the advertisement to the user through an email interface.

3. The method of claim 1, the providing comprising:
displaying the advertisement to the user through at least one of a website, an application interface, or a push notification.

4. The method of claim 1, the recommendation content comprising a recommendation request by the user, and the method comprising:
identifying suggested content corresponding to the recommendation request; and
providing the suggested content as a recommendation for the recommendation request.

5. The method of claim 4, the suggested content comprising content identified from at least one of:
a website, a community forum, a blog post, a social network profile, an article, a newsfeed, a recommendation database, a search engine page, or an application.

6. The method of claim 1, the identifying an advertisement comprising:
responsive to evaluating a user profile for the user, selecting a first advertisement, but not a second advertisement, based upon the first advertisement, but not the second advertisement, corresponding to the user profile of the user.

7. The method of claim 1, comprising:
displaying an advertisement user interface comprising at least one of:
a rate user interface element used to rate the advertisement;
a copy user interface element used to copy a link to the advertisement;
a save user interface element used to save the advertisement as a file;
a share user interface element used to share the advertisement with one or more community members; or
a comment user interface element used to comment on the advertisement.

8. The method of claim 7, the message communication corresponding to a forum post within a community forum, and the method comprising:
responsive to the user selecting the share user interface element, sharing the advertisement with one or more community members through the community forum.

9. The method of claim 7, comprising:
responsive to the user selecting the share user interface element, sharing the advertisement with a second user through non-public message communication.

10. The method of claim 1, comprising:
collecting interaction information regarding user interaction with the advertisement; and
utilizing the interaction information to determine whether to subsequently associate the advertisement with the recommendation content.

11. The method of claim 1, message communication corresponding to a forum post within a community forum, the forum post comprising at least one of a recommendation request or a recommendation.

12. The method of claim 11, comprising:
storing the recommendation as an archived recommendation in a recommendation database.

13. The method of claim 1, comprising:
identifying an archived recommendation from a recommendation database based upon the recommendation content; and
providing the archived recommendation as a recommendation for the recommendation content.

14. The method of claim 1, the message communication comprising:
an email message, an instant message, a social media message, an in-app message, a video message, a text message, a forum post, or an audio message.

15. The method of claim 1, the providing the advertisement comprising:
generating a set of advertisements associated with one or more recommendations for the recommendation content;
ranking the set of advertisements to create a ranked set of advertisements based upon a ranking metric; and
displaying an advertisement from the ranked set of advertisements.

16. A non-transitory computer readable medium comprising computer executable instructions that when executed by a processor perform a method for providing an advertisement to a user, comprising:
evaluating message communication of a user to identify message content;
evaluating the message content to identify a recommendation request;
identifying suggested content corresponding to the recommendation request;
providing the suggested content as a recommendation for the recommendation request to the user.

17. The method of claim 16, comprising:
collecting interaction information regarding user interaction with the recommendation; and
utilizing the interaction information to determine at least one of:
whether to subsequently associate the recommendation with the recommendation content; or
whether to increase or decrease a cost of an advertisement opportunity.

18. The method of claim 16, the suggested content comprising a community recommendation from a community forum, and the method comprising:
responsive to identifying the community recommendation, requesting permission to store the community recommendation as a archived recommendation in a recommendation database.

19. A system for providing a recommendation to a user, comprising:
an advertisement generator component configured to:
evaluate message communication of a user to identify message content corresponding to communication activity;
evaluate the message content to identify a recommendation request;
identify an archived recommendation from a recommendation database corresponding to the recommendation request;
provide the archived recommendation as a recommendation for the recommendation request.

20. The system of claim 19, the recommendation associated with an advertisement, and the system comprising:
an advertisement user interface component configured to at least one of:
rate the advertisement in response to the user selecting a rate user interface element;
copy the advertisement in response to the user selecting a copy user interface element;
save the advertisement as a file in response to the user selecting a save user interface element;
share the advertisement with one or more community members in response to the user selecting a share user interface element; or
comment on the advertisement in response to the user selecting a comment user interface element.
